(19) United States
(12) Patent Application Publication
(10) Pub. No.: US 2026/0059219 A1
(43) Pub. Date: Feb. 26, 2026

(54) BATTERY AND ELECTRONIC DEVICE COMPRISING SAME

(71) Applicant: Samsung Electronics Co., Ltd., Suwon-si (KR)

(72) Inventors: Sungjin KIM, Suwon-si (KR); Yongwook PARK, Suwon-si (KR); Haekeu PARK, Suwon-si (KR); Yongbum JEUNG, Suwon-si (KR); Kiwook HAN, Suwon-si (KR); Changryong HEO, Suwon-si (KR)

(21) Appl. No.: 19/371,506

(22) Filed: Oct. 28, 2025

Related U.S. Application Data
(63) Continuation of application No. PCT/KR2024/005936, filed on May 2, 2024.

(30) Foreign Application Priority Data
May 4, 2023 (KR) 10-2023-0058780
Jun. 27, 2023 (KR) 10-2023-0082502

(51) Int. Cl. H04R 1/10; H01M 10/04; H01M 50/247; H01M 50/284

(52) U.S. Cl. CPC H04R 1/1025; H01M 10/0427; H01M 10/0431; H01M 50/247; H01M 50/284; H04R 1/1016; H01M 2220/30

(57) ABSTRACT

An electronic device is provided. The electronic device includes a battery including a cathode having a first length and an anode having a second length different from the first length, a speaker stacked with the battery, and a bracket disposed between the battery and the speaker, wherein a conductive member is disposed on a first surface of the bracket acing the battery, and at least a portion of the conductive member is formed along an edge of the first surface, wherein the conductive member includes a first end electrically connected to a first portion of the negative electrode, and a second end electrically connected to a second portion of the negative electrode, wherein the battery is configured such that a magnetic field is formed by a current generated due to a difference between lengths of the anode and the cathode, and wherein the conductive member is formed to cancel out at least a portion of the magnetic field.

### CROSS-REFERENCE TO RELATED APPLICATION(S)

This application is a continuation application, claiming priority under 35 U.S.C. § 365(c), of an International application No. PCT/KR2024/005936, filed on May 2, 2024, which is based on and claims the benefit of a Korean patent application number 10-2023-0058780, filed on May 4, 2023, in the Korean Intellectual Property Office, and of a Korean patent application number 10-2023-0082502, filed on Jun. 27, 2023, in the Korean Intellectual Property Office, the disclosure of each of which is incorporated by reference herein in its entirety.

### BACKGROUND

### 1. Field

The disclosure relates to a battery and an electronic device including the same.

### 2. Description of Related Art

Due to the advancement of information and communication technology and semiconductor technology, the distribution and use of various electronic devices are rapidly increasing. In particular, recent electronic devices have been developed to enable communication, while being carried. Further, electronic devices may output stored information as sound or an image. As the integration level of electronic devices increases and ultra-high-speed, large-capacity wireless communication becomes widespread, a single electronic device such as a mobile communication terminal has been equipped with various functions in recent years. For example, not only communication functions but also multimedia functions such as music/video playback are integrated in a single electronic device. Such electronic devices are being miniaturized so that users may conveniently carry them.

As the use of electronic devices becomes commonplace, user demands for the portability and usability of electronic devices may increase. In response to these user demands, wearable electronic devices, such as wireless earphones, smart watches, or glasses-type electronic devices, which may be carried and used while worn on the body, are being commercialized.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a battery and an electronic device including the same.

Additional aspects will be set forth in part in the description which follows and, in part, will be apparent from the description, or may be learned by practice of the presented embodiments.

In accordance with an aspect of the disclosure, an electronic device is provided. The electronic device includes a battery including a cathode having a first length and an anode having a second length different from the first length, a speaker stacked with the battery, and a bracket disposed between the battery and the speaker, wherein a conductive member is disposed on a first surface facing the battery and at least a portion of the conductive member formed along an edge of the first surface, wherein the conductive member includes a first end electrically connected to a first portion of the battery, and a second end electrically connected to a second portion of the battery, wherein the battery is configured such that a magnetic field is formed by current generated due to a difference between the lengths of the anode and the cathode, and wherein the conductive member is formed to cancel out at least a portion of the magnetic field.

In accordance with another aspect of the disclosure, an electronic device is provided. The electronic device includes a battery including a cathode having a first length and an anode having a second length different from the first length, a speaker stacked with the battery, a first printed circuit board electrically connected to the battery, a bracket disposed between the battery and the speaker, a first conductive printed circuit board extended from the first printed circuit board. The first conductive printed circuit board includes a first end electrically connected to a first portion of the battery, and a second end electrically connected to a second portion of the battery. A magnetic field is formed in the battery by current generated due to a difference between the lengths of the anode and the cathode, and the first conductive printed circuit board (PCB) is formed to cancel out at least a portion of the magnetic field.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an audio module according to an embodiment of the disclosure;

FIG. 3 is a perspective view illustrating an electronic device according to an embodiment of the disclosure;

FIG. 4 is a cross-sectional view illustrating an electronic device viewed from a side according to an embodiment of the disclosure;

FIG. 5 is a side view illustrating a speaker and a battery viewed from a side according to an embodiment of the disclosure;

FIG. 6 is an exploded perspective view illustrating a battery, a speaker, and a bracket according to an embodiment of the disclosure;

FIG. 7 is an exploded perspective view illustrating a battery according to an embodiment of the disclosure;

FIGS. 8A and 8B are diagrams illustrating a battery viewed from above and from below, respectively according to various embodiments of the disclosure;

FIG. 9 is a diagram illustrating an electrode assembly viewed from above according to an embodiment of the disclosure;

FIG. 10 is an exploded perspective view illustrating a battery and a bracket alone according to an embodiment of the disclosure;

FIG. 11 is a diagram illustrating a bracket and a conductive member viewed from above according to an embodiment of the disclosure;

FIG. 12 is a diagram illustrating the directions of current in a battery and a conductive member according to an embodiment of the disclosure;

FIG. 13 is a diagram illustrating the battery and the bracket of FIG. 11, taken along line A-A′ according to an embodiment of the disclosure;

FIG. 14 is a photograph illustrating a conductive member in contact with a battery at two or more points according to an embodiment of the disclosure;

FIG. 15 is a photograph illustrating a conductive member in contact with a battery at one point according to an embodiment of the disclosure;

FIG. 16 is a diagram illustrating the results of noise measurements based on the number of contact points between a battery and a conductive member according to an embodiment of the disclosure;

FIG. 17 is a photograph illustrating a circular conductive member according to an embodiment of the disclosure;

FIG. 18 is a photograph illustrating a conductive member with a curvature of 180 degrees between a first end and a second end according to an embodiment of the disclosure;

FIG. 19 is a photograph illustrating a conductive member with a curvature of 270 degrees between a first end and a second end according to an embodiment of the disclosure;

FIG. 20 is a diagram illustrating the results of noise measurements based on shapes of a conductive member according to an embodiment of the disclosure;

FIG. 21 is a side view illustrating an electronic device 300 excluding a housing according to an embodiment of the disclosure;

FIG. 22 is an exploded perspective view illustrating a battery and a bracket alone according to an embodiment of the disclosure; and

FIG. 23 is a diagram illustrating the battery and the bracket of FIG. 22, taken along line A-A′ according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

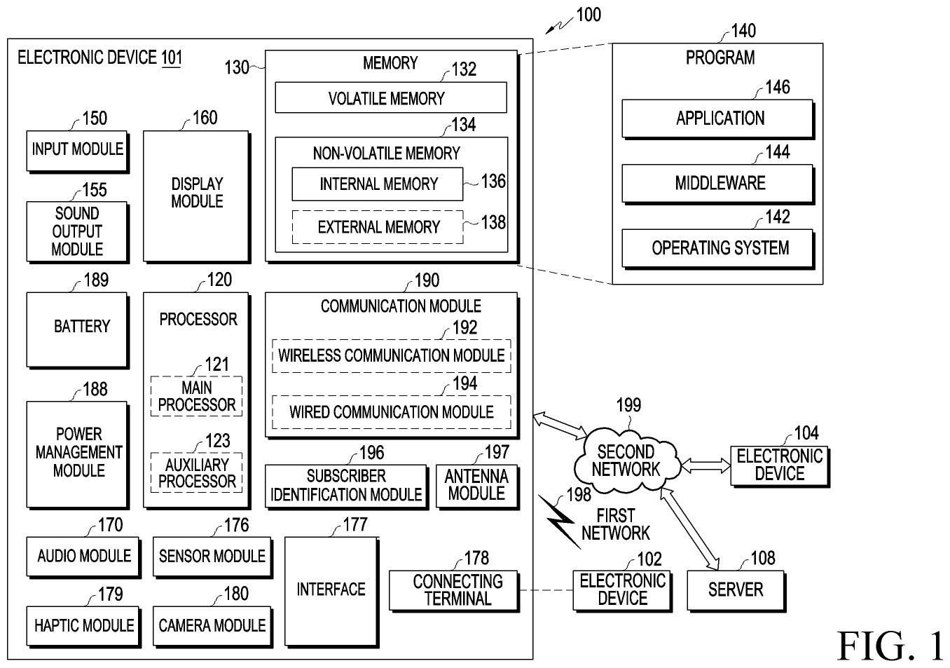

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the strength of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to an embodiment, the antenna module 197 may form an mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1^{st}” and “2^{nd}” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, logic, logic block, part, or circuitry. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

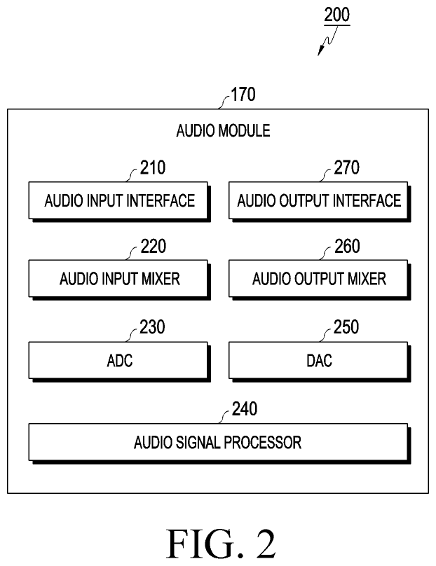

FIG. 2 is a block diagram 200 illustrating the audio module 170 according to an embodiment of the disclosure.

Referring to FIG. 2, the audio module 170 may include, for example, an audio input interface 210, an audio input mixer 220, an analog-to-digital converter (ADC) 230, an audio signal processor 240, a digital-to-analog converter (DAC) 250, an audio output mixer 260, or an audio output interface 270.

The audio input interface 210 may receive an audio signal corresponding to a sound obtained from the outside of the electronic device 101 via a microphone (e.g., a dynamic microphone, a condenser microphone, or a piezo microphone) that is configured as part of the input module 150 (e.g., the input module 150 in FIG. 1) or separately from the electronic device 101 (e.g., the electronic device 101 in FIG. 1). For example, if an audio signal is obtained from an external electronic device (e.g., the external electronic device 102) (e.g., a headset or a microphone), the audio input interface 210 may be connected to the external electronic device 102 directly via a connecting terminal (e.g., the connecting terminal 178 in FIG. 1), or wirelessly (e.g., Bluetooth communication) via a wireless communication module (e.g., the wireless communication module 192 in FIG. 1) to receive the audio signal. According to an embodiment, the audio input interface 210 may receive a control signal (e.g., a volume adjustment signal received via an input button) related to the audio signal obtained from the external electronic device 102. The audio input interface 210 may include a plurality of audio input channels and may receive a different audio signal via a corresponding one of the plurality of audio input channels, respectively. According to an embodiment, additionally or alternatively, the audio input interface 210 may receive an audio signal from another component (e.g., the processor 120 or the memory 130 in FIG. 1) of the electronic device 101.

The audio input mixer 220 may synthesize a plurality of input audio signals into at least one audio signal. For example, according to an embodiment, the audio input mixer 220 may synthesize a plurality of analog audio signals input via the audio input interface 210 into at least one analog audio signal.

The ADC 230 may convert an analog audio signal into a digital audio signal. For example, according to an embodiment, the ADC 230 may convert an analog audio signal received via the audio input interface 210 or, additionally or alternatively, an analog audio signal synthesized via the audio input mixer 220 into a digital audio signal.

The audio signal processor 240 may perform processing on a digital audio signal received via the ADC 230 or a digital audio signal received from another component of the electronic device 101. For example, according to an embodiment, the audio signal processor 240 may perform changing a sampling rate, applying one or more filters, interpolation processing, amplifying or attenuating a whole or partial frequency bandwidth, noise processing (e.g., attenuating noise or echoes), changing channels (e.g., switching between mono and stereo), mixing, or extracting a specified signal for one or more digital audio signals. According to an embodiment, one or more functions of the audio signal processor 240 may be implemented in the form of an equalizer.

The DAC 250 may convert a digital audio signal into an analog audio signal. For example, according to an embodiment, the DAC 250 may convert a digital audio signal processed by the audio signal processor 240 or a digital audio signal obtained from another component (e.g., the processor 120 or the memory 130) of the electronic device 101 into an analog audio signal.

The audio output mixer 260 may synthesize a plurality of audio signals, which are to be output, into at least one audio signal. For example, according to an embodiment, the audio output mixer 260 may synthesize an analog audio signal converted by the DAC 250 and another analog audio signal (e.g., an analog audio signal received via the audio input interface 210) into at least one analog audio signal.

The audio output interface 270 may output an analog audio signal converted by the DAC 250 or, additionally or alternatively, an analog audio signal synthesized by the audio output mixer 260 to the outside of the electronic device 101 via the sound output module 155. The sound output module 155 may include, for example, a speaker, such as a dynamic driver or a balanced armature driver, or a receiver. According to an embodiment, the sound output module 155 may include a plurality of speakers. For example, the audio output interface 270 may output audio signals having a plurality of different channels (e.g., stereo channels or 5.1 channels) via at least some of the plurality of speakers. According to an embodiment, the audio output interface 270 may be connected to the external electronic device 102 (e.g., an external speaker or a headset) directly via the connecting terminal 178 or wirelessly via the wireless communication module 192 to output an audio signal.

According to an embodiment, the audio module 170 may generate, without separately including the audio input mixer 220 or the audio output mixer 260, at least one digital audio signal by synthesizing a plurality of digital audio signals using at least one function of the audio signal processor 240.

According to an embodiment, the audio module 170 may include an audio amplifier (not shown) (e.g., a speaker amplifying circuit) that is capable of amplifying an analog audio signal input via the audio input interface 210 or an audio signal that is to be output via the audio output interface 270. According to an embodiment, the audio amplifier may be configured as a module separate from the audio module 170.

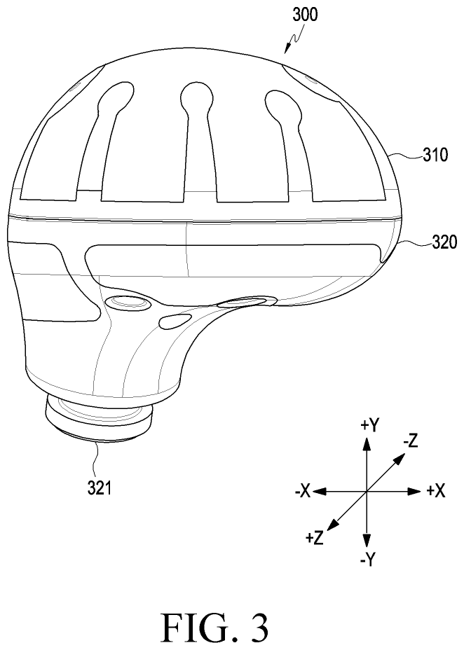

FIG. 3 is a perspective view of an electronic device 300 according to an embodiment of the disclosure.

The electronic device 300 illustrated in FIG. 3 may be the same as or similar to the electronic device 101 illustrated in FIG. 1. Therefore, a description of the same components may be omitted.

Referring to FIG. 3, the electronic device 300 may include a first housing 310 and a second housing 320 connected (or coupled) to the first housing 310.

According to an embodiment, the electronic device 300 may be an electronic device wearable on a user's body part (e.g., the user's ear or head). The electronic device 300 may include an in-ear earset, an in-ear headset, or a hearing aid, and may also include an electronic device with a speaker.

In the drawings of the disclosure, a canal-type in-ear earset, which is worn in the external auditory canal leading from the auricle to the eardrum, may be described as an example of the electronic device 300. The disclosure is not limited thereto, and the electronic device 300 may be an open-type earset worn on the auricle.

According to an embodiment, the electronic device 300 may be connected to an external electronic device wiredly or wirelessly. In this case, the electronic device 300 may function as an audio output device that outputs an acoustic signal generated by the external electronic device to the outside. In an example, the electronic device 300 may function as an audio input device for receiving an audio signal corresponding to a sound obtained from the outside of the external electronic device.

According to an embodiment, the first housing 310 and the second housing 320 may include a portion of a curved surface with a designated curvature. In an example, the first housing 310 may seamlessly extend from one end thereof to be connected to the second housing 320. For example, the first housing 310 and the second housing 320 may be formed to be in contact with each other on an X-Z plane.

According to an embodiment, the first housing 310 or the second housing 320 may be formed of coated or tinted glass, ceramic, a polymer, a metal (e.g., aluminum, stainless steel (STS), or magnesium), a resin (e.g., polycarbonate, polyethylene, polypropylene, or polystyrene), or a combination of at least two of these materials. In an example, the first housing 310 and the second housing 320 may be formed by injection molding.

According to an embodiment, the second housing 320 may include a protrusion 321 that is seated in an ear of the user using the electronic device 300. In an example, the protrusion 321 may be formed to extend from the second housing 320 in a −Y-axis direction.

The electronic device 300 illustrated in FIG. 3 is merely one example and does not limit the form of a device to which the technical idea of the disclosure is applied. The technical idea of the disclosure is applicable to various types of wearable electronic devices that include a protrusion seated in an ear. For example, the technical idea of the disclosure may also be applied to a bean-shaped wearable electronic device.

For convenience of description, an embodiment will be described below in the context of the electronic device 300 illustrated in FIG. 3.

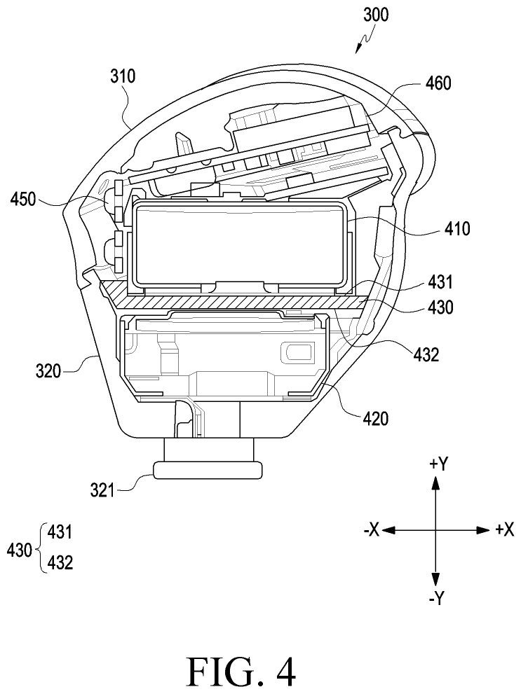

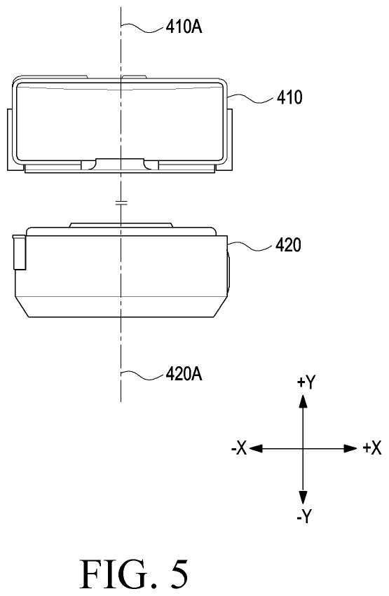

FIG. 4 is a cross-sectional view illustrating the electronic device 300 viewed from a side according to an embodiment of the disclosure. The cross-sectional view of FIG. 4 may be understood as a side cross-sectional view of the electronic device 300 of FIG. 3 viewed from a +Z-axis direction. FIG. 5 is a side view illustrating a speaker 420 and a battery 410, viewed from a side, according to an embodiment of the disclosure.

Referring to FIGS. 4 and 5, the electronic device 300 may include the battery 410, the speaker 420, a bracket 430 disposed between the battery 410 and the speaker 420, and printed circuit boards 450 and 460 (e.g., PCBs, printed board assemblies (PBAs), flexible PCBs (FPCB), or rigid-flexible PCBs (RFPCBs)) in an internal space formed by the first housing 310 and the second housing 320. In an example, the electronic device 300 may further include other components in addition to the components illustrated in FIG. 4. For example, a wireless communication circuit or a microphone may be further included in the internal space formed by the first housing 310 and the second housing 320. In another example, some of the components illustrated in FIG. 4 may be omitted or replaced with other similar components in the electronic device 300. For example, the electronic device 300 may be configured such that the protrusion 321 does not protrude outward from the electronic device 300. The structures of FIGS. 4 and 5 may be selectively combined with the structure of FIG. 3.

According to an embodiment, the electronic device 300 may include the speaker 420 adjacent to the protrusion 321 inside the second housing 320. The speaker 420 may perform a function of receiving an electrical signal through a circuit (e.g., the PCBs 450 and 460) inside the electronic device 300 and converting it into physical vibration.

According to an embodiment, the speaker 420 may be disposed in parallel with the battery 410 within the second housing 320. For example, the speaker 420 may be stacked with the battery 410 along a Y axis. For example, the speaker 420 may be disposed coaxially with the battery 410.

According to an embodiment, the speaker 420 may output a front-radiated sound through one surface facing the protrusion 321 (e.g., in a −Y-axis direction in FIG. 4). The speaker 420 may output a rear-radiated sound through one surface facing in the opposite direction to the protrusion 321 (e.g., in a +Y-axis direction in FIG. 4).

According to an embodiment, referring to FIG. 5, the speaker 420 may be formed in a generally circular shape. The speaker 420 may be formed in a circular shape with respect to a central axis 420A.

According to an embodiment, the speaker 420 may convert an electrical signal into wave energy by receiving power directly or indirectly from the battery 410. According to an embodiment, the speaker 420 may be electrically directly connected to the battery 410 and receive power from the battery 410. According to an embodiment, the speaker 420 may be electrically connected to a first PCB 450, and the first PCB 450 may be electrically connected to the battery 410, so that the speaker 420 may receive power from the battery 410 via the first PCB 450. According to an embodiment, the speaker 420 may be electrically connected to a power management module (e.g., the power management module 188 in FIG. 1) and receive power from the power management module 188.

According to an embodiment, the battery 410 may be disposed in the internal space of the electronic device 300 formed by the coupling between the first housing 310 and the second housing 320. According to an embodiment, the battery 410 may supply power to at least one component of the electronic device 300. According to an embodiment, the battery 410 may be a rechargeable secondary battery. In an example, components included in the electronic device 300 may be driven by power output from the battery 410.

According to an embodiment, the battery 410 may be formed in various shapes. According to an embodiment, the battery 410 may be a small battery to be disposed in a miniaturized wearable electronic device (e.g., the electronic device 300 in FIG. 3). For example, the battery 410 may be a coin-shaped or cylindrical battery.

According to an embodiment, the battery 410 may include a plurality of batteries. For example, the battery 410 may include an inner battery and an outer battery surrounding the inner battery.

According to an embodiment, the battery 410 may be configured to include a negative electrode plate, a positive electrode plate, a separator, and an electrolyte. In an example, the negative electrode plate and the positive electrode plate included in the battery 410 may form a winding structure.

According to an embodiment, the battery 410 may be formed in a generally circular shape. The battery 410 may be formed in a circular shape with respect to a central axis 410A. According to an embodiment, the battery 410 may include a bottom surface facing the speaker 420 (e.g., in the −Y-axis direction in FIG. 4) and a top surface opposite to the bottom surface (e.g., in a +Y-axis direction in FIG. 4).

According to an embodiment, the speaker 420 and the battery 410 may be disposed adjacent to each other. For example, the speaker 420 and the battery 410 may be stacked. For example, the speaker 420 may be disposed in one direction of the battery 410 (e.g., in the −Y-axis direction). According to an embodiment, the bottom surface of the battery 410 (e.g., in the −Y-axis direction in FIG. 4) may be disposed in an area corresponding to the speaker 420. In an example, the bottom surface of the battery 410 (e.g., in the −Y-axis direction in FIG. 4) may be disposed to face the speaker 420.

According to an embodiment, the speaker 420 and the battery 410 may be arranged coaxially. For example, the central axis 420A of the speaker 420 and the central axis 410A of the battery 410 may be disposed adjacent to each other or coincide with each other. However, the arrangement and position of the speaker 420 and the battery 410 are not limited to the above embodiment and may be subject to various design modifications according to the sizes or arrangement relationship of surrounding structures.

According to an embodiment, the bracket 430 may be disposed in the internal space of the electronic device 300 formed by the coupling of the first housing 310 and the second housing 320. According to an embodiment, the bracket 430 may be disposed between the battery 410 and the speaker 420.

According to an embodiment, the first PCB 450 may be disposed in the internal space of the electronic device 300 formed by the coupling of the first housing 310 and the second housing 320. In an example, at least one electronic component (e.g., the communication module 190 or the sensor module 176 in FIG. 1) may be mounted on the first PCB 450.

According to an embodiment, the PCBs 450 and 460 may include PCBs or FPCBs. According to an embodiment, the PCBs 450 and 460 may include the first PCB 450 connected to the battery 410, and a second PCB 460 connected to the first PCB 450. For example, the first PCB 450 may be an FPCB. For example, the second PCB 460 may be a main PCB.

According to an embodiment, the first PCB 450 may be electrically connected to the battery 410 and disposed to surround at least a portion of a side surface of the battery 410.

According to an embodiment, the internal space formed by the coupling between the first housing 310 and the second housing 320 may further form a space for accommodating other electronic components including the speaker 420, the battery 410, the bracket 430, the first PCB 450, and the second PCB 460. Although FIG. 4 illustrates the speaker 420 and the battery 410 arranged in parallel, the shape of the interior of the first housing 310 and the second housing 320 and the arrangement of each component are not necessarily limited thereto. The detailed arrangement of the components included inside the first housing 310 and the second housing 320 may vary according to embodiments.

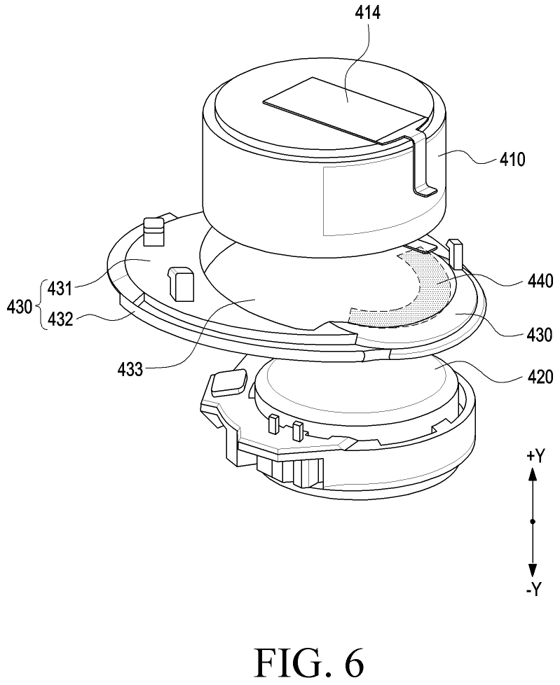

FIG. 6 is an exploded perspective view illustrating the battery 410, the speaker 420, and the bracket 430 according to an embodiment of the disclosure.

Referring to FIG. 6, according to an embodiment, an electronic device (e.g., the electronic device 101 in FIG. 1 or the electronic device 300 in FIG. 3) may include a housing (e.g., the first housing 310 and the second housing 320 in FIGS. 3 and 4), the battery 410 disposed inside the housing, the speaker 420 stacked with the battery 410, and the bracket 430. For example, the electronic device of FIG. 6 is the electronic device 300 of FIGS. 4 and 5 with the housing (e.g., the first housing 310 and the second housing 320 in FIGS. 3 and 4) removed.

Referring to FIG. 6, the configurations of the speaker 420, the battery 410, and the bracket 430 of FIG. 6 may be wholly or partially identical to those of the speaker 420, the battery 410, and the bracket 430 of FIGS. 4 and 5. The structure of FIG. 6 may be selectively combined with the structure of FIGS. 4 and 5.

According to an embodiment, the bracket 430 may include a first surface 431 facing the battery 410 (e.g., in the +Y-axis direction in FIG. 4) and a second surface 432 facing the speaker 420 and opposite to the first surface 431 (e.g., in the −Y-axis direction in FIG. 4). The bracket 430 may be configured such that the first surface 431 (e.g., in the +Y-axis direction in FIG. 4) faces the battery 410, and the second surface 432 (e.g., in the −Y-axis direction in FIG. 4) faces the speaker 420.

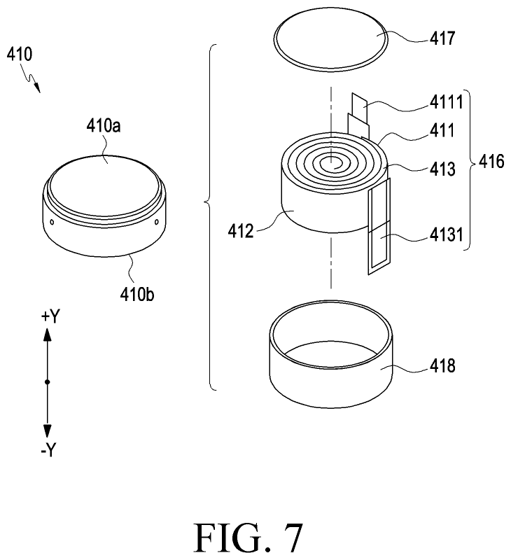

According to an embodiment, the bracket 430 may provide a space in which the battery 410 is seated. According to an embodiment, the first surface 431 of the bracket 430 may include a recessed portion 433 in which the battery 410 is seated, and a portion facing the battery 410 is recessed in the −Y-axis direction. The recessed portion 433 may correspond to the shape of the bottom surface of the battery 410 (e.g., a bottom surface 410b in FIG. 7). For example, a bottom surface 410b of the battery 410 and the recessed portion 433 may be circular. According to an embodiment, the bracket 430 may be formed of, for example, a metallic material and/or a non-metallic (e.g., polymer) material. When the bracket 430 is at least partially formed of a metallic material, a portion of the bracket 430 may function as an antenna.

According to an embodiment, the bracket 430 may include a conductive member 440 formed along an edge of the first surface 431 of the bracket 430. For example, the conductive member 440 may be formed along at least a portion of a curved edge of the recessed portion 433 of the bracket 430, which will be described later.

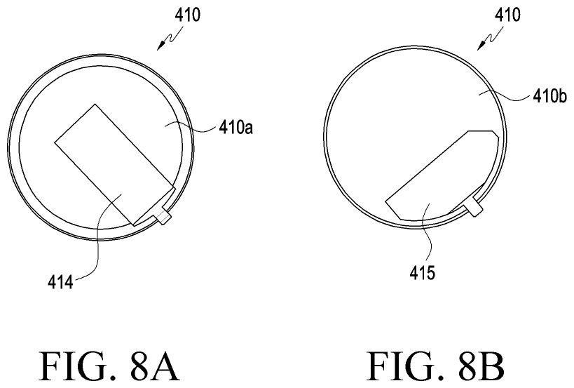

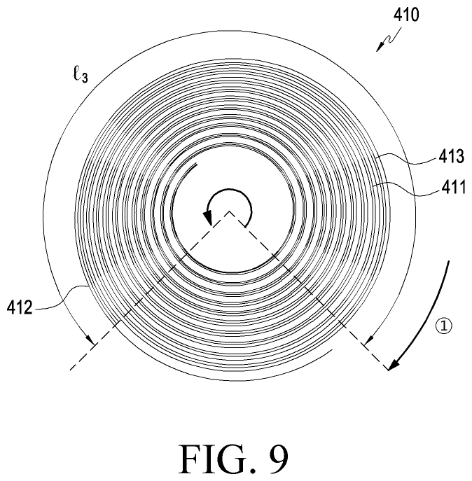

FIG. 7 is an exploded perspective view illustrating the battery 410 according to an embodiment of the disclosure. FIGS. 8A and 8B are diagrams illustrating the battery 410 viewed from above and below, respectively according to various embodiments of the disclosure. FIG. 9 is a diagram illustrating an electrode assembly viewed from above according to an embodiment of the disclosure.

Referring to FIGS. 7, 8A, 8B, and 9, according to an embodiment, an electronic device (e.g., the electronic device 101 in FIG. 1 or the electronic device 300 in FIG. 3) may include the battery 410 disposed inside the electronic device (e.g., the electronic device 101 in FIG. 1 or the electronic device 300 in FIG. 3).

Referring to FIGS. 7, 8A, 8B, and 9, the configuration of the battery 410 in FIGS. 7, 8A, 8B, and 9 may be wholly or partially identical to that of the battery 410 in FIGS. 4 to 6. The structures of FIGS. 7, 8A, 8B, and 9 may be selectively combined with the structures of FIGS. 4 to 6.

According to an embodiment, referring to FIG. 7, the battery 410 may be a coin-type battery 410. The battery 410 may include an exterior member 418 in the form of a can and/or a cup, a cover 417 sealing the exterior member 418, an electrode assembly 416 of a jelly-roll or stack structure, and an electrolyte (not shown) injected into the battery 410, which are coupled to each other. The electrode assembly 416 may include at least one cathode 411, at least one anode 412, at least one separator 413 disposed between the at least one cathode 411 and the at least one anode 412, a cathode jelly roll 4111 connected to an end of the cathode 411, and an anode jelly roll 4131 connected to an end of the anode 412. According to an embodiment, the electrode assembly 416 may be in a form where the cathode 411, the anode 412, and the separator 413 are sequentially wound from the central axis, as illustrated in FIG. 7.

According to an embodiment, the cathode 411 may include a cathode substrate, a cathode mixture (a cathode active material, a conductive material, and a binder) coated on one surface of the cathode substrate, and the cathode jelly roll 4111 attached to one surface of the cathode substrate. The cathode jelly roll 4111 may be disposed to protrude in an upward direction (the +Y-axis direction) and disposed to be in contact with the top surface 410a of the battery 410. According to an embodiment, referring to FIG. 8A, a cathode tab 414 may be disposed on the top surface 410a of the battery 410. The cathode tab 414 may be disposed to cover at least a portion of the top surface 410a of the battery 410. The cathode tab 414 may be, for example, rectangular in shape.

According to an embodiment, the anode 412 may include an anode substrate, an anode mixture (an anode active material, a conductive material, and a binder) coated on one surface of the anode substrate, and the anode jelly roll 4131 attached to one surface of the anode substrate. The anode jelly roll 4131 may be disposed to protrude in a downward direction (the −Y-axis direction) and disposed to be in contact with the bottom surface 410b of the battery 410. According to an embodiment, referring to FIG. 8B, an anode tab 415 may be disposed on the bottom surface 410b of the battery 410. The anode tab 415 may be disposed to cover at least a portion of the bottom surface 410b of the battery 410. A portion of the anode tab 415 may be formed along an edge of the bottom surface 410b of the battery 410.

According to an embodiment, the electrode assembly 416 of the battery 410 may be in a jelly roll form created by winding the cathode 411 and the anode 412 with the separator 413 in between. The cathode 411, the anode 412, and the separator 413 may be wound in a first direction (e.g., clockwise) or a second direction (e.g., counter-clockwise) opposite to the first direction. The winding direction of the cathode 411, the anode 412, and the separator 413 is not limited, and may be subject to various design modifications according to a manufacturing method.

According to embodiments, the cathode 411 may include a cathode substrate and a cathode mixture surrounding the cathode substrate. For example, the cathode substrate may be disposed between a pair of cathode mixtures. According to an embodiment, the cathode substrate may include aluminum (Al). According to an embodiment, the cathode mixture may include a lithium (Li) oxide containing a transition metal (e.g., at least one of cobalt (Co), manganese (Mn), or iron (Fe)).

According to an embodiment, the anode 412 may include an anode substrate and an anode mixture surrounding the anode substrate. For example, the anode substrate may be disposed between a pair of anode mixtures. According to an embodiment, the anode substrate may include copper (Cu). According to an embodiment, the anode mixture may include graphite and/or lithium (Li) titanium (Ti) oxide.

According to embodiments, the separator 413 may be located between the cathode 411 and the anode 412, and may be a component for insulation. According to embodiments, the separator 413 may be a non-conductive porous body with pores, which may physically separate the cathode 411 and the anode 412 from each other and move a designated substance (e.g., Li ions). According to an embodiment, the separator 413 may be a synthetic resin (e.g., polyethylene or polypropylene).

According to embodiments, the electrode assembly 416 of the battery 410 may include the cathode jelly roll 4111 and the anode jelly roll 4131. According to an embodiment, the cathode jelly roll 4111 may be electrically connected to the cathode 411, and the anode jelly roll 4131 may be electrically connected to the anode 412. For example, the cathode jelly roll 4111 may be connected to the cathode substrate, and the anode jelly roll 4131 may be connected to the anode substrate.

According to embodiments, the cathode tab 414 and the anode tab 415 may be located in different directions with respect to the battery 410. For example, the cathode tab 414 may be located in the upward direction of the battery 410 (e.g., the +Y direction in FIG. 7), and the anode tab 415 may be located in the downward direction of the battery 410 (e.g., the −Y direction in FIG. 7). As the cathode tab 414 and the anode tab 415 are spaced apart from each other, internal short circuit of the battery (e.g., the battery 410 in FIG. 4) may be prevented or reduced.

According to an embodiment, the first PCB 450 may be electrically connected to the battery 410. For example, a solder of the first PCB 450 may be electrically connected to the anode tab 415 and the cathode tab 414 of the battery 410. According to an embodiment, the second PCB 460 may be disposed on the battery 410 (e.g., in a +Z direction in FIG. 6) and electrically connected to the first PCB 450.

According to an embodiment, the first PCB 450 may include a power line (not shown) VBAT electrically connected to the cathode 411 of the battery 410, a ground line (not shown) GND electrically connected to the anode 412, and a signal line (not shown).

According to an embodiment, current may flow as follows. Current may flow from the cathode 411 of the battery 410 to the power line (not shown) of the first PCB 450 through the cathode tab 414 electrically connected to the cathode 411, and from the power line (not shown) of the first PCB 450 to the anode tab 415 and the anode 412 of the battery 410 through the ground line (not shown) of the first PCB 450. For example, current may flow from the cathode 411 of the battery 410 to the power line (not shown) of the first PCB (FPCB) 450 through the cathode tab 414 electrically connected to the cathode 411, from the power line (not shown) of the first PCB (FPCB) 450 to the second PCB (main PBA) 460, from the second PCB (main PBA) 460 to the ground line (not shown) of the first PCB (FPCB) 450, from the ground line (not shown) of the first PCB (FPCB) 450 to the battery protection circuit module (PCM) IC, and then to the anode tab 415 and the anode 412 of the battery 410 through the battery PCM IC.

According to an embodiment, the lengths of the cathode 411 and the anode 412 of the battery 410 may be different. The length of the cathode 411 may be a first length (e.g., the length from the central axis of the battery 410 to the cathode jelly roll 4111), and the length of the anode 412 may be a second length (e.g., the length from the central axis of the battery 410 to the anode jelly roll 4131) different from the first length. The difference between the lengths of the cathode 411 and the anode 412 may be a third length 13. According to an embodiment, the second length may be larger than the first length. For example, the second length may be larger than the first length by the third length 13. However, the lengths of the cathode 411 and the anode 412 are not limited to the above embodiment, and may be subject to various design modifications according to design methods.

According to an embodiment, a first magnetic field may be formed by the cathode 411, and a second magnetic field may be formed by the anode 412 in a direction opposite to a direction of the first magnetic field. Since the cathode 411 and the anode 412 are wound in an overlapping manner, the magnetic fields may be canceled out in an overlapping section of the cathode 411 and the anode 412.

According to an embodiment, referring to FIG. 9, since the lengths of the cathode 411 and the anode 412 are different, a first current formed to flow in a first winding direction \textcircled{1} may flow in the battery 410 due to the difference between the lengths of the anode 412 and the cathode 411. A third magnetic field may be formed by the first current. For example, when the second length of the anode 412 (e.g., the length from the central axis of the battery 410 to the anode jelly roll 4131) is larger than the first length of the cathode 411 (e.g., the length from the central axis of the battery 410 to the cathode jelly roll 4111), the third magnetic field may be formed by a (−) current due to the third length 13 of a part where only the anode 412 is wound, excluding a section where the anode 412 and the cathode 411 overlap and thus the magnetic fields are canceled out. When the first current is a (−) current, the first winding direction \textcircled{1} may be opposite to the winding direction of the cathode 411, the anode 412, and the separator 413. For example, when the winding direction of the cathode 411, the anode 412, and the separator 413 is clockwise, the first winding direction \textcircled{1} may be counter-clockwise. For example, when the winding direction of the battery 410 is counter-clockwise, the first winding direction \textcircled{1} may be clockwise.

Generally, the third magnetic field generated due to the difference 13 between the lengths of the anode 412 and the cathode 411 may affect the adjacent speaker 420. For example, current may be induced in a coil (not shown) included inside the speaker 420 by the third magnetic field, and this may affect the vibration of a diaphragm (not shown) included inside the speaker 420, causing noise (e.g., an electromagnetic field). For example, periodic noise may occur due to a peak current.

According to an embodiment, an electronic device (e.g., the electronic device 101 in FIG. 1 or the electronic device 300 in FIG. 3) may effectively mitigate or eliminate noise by disposing the conductive member 440 on the bracket 430 disposed between the battery 410 and the speaker 420, such that at least a portion of the magnetic field generated by the current caused by the difference between the lengths of the anode and cathode of the battery 410 is canceled out. This will be described later.

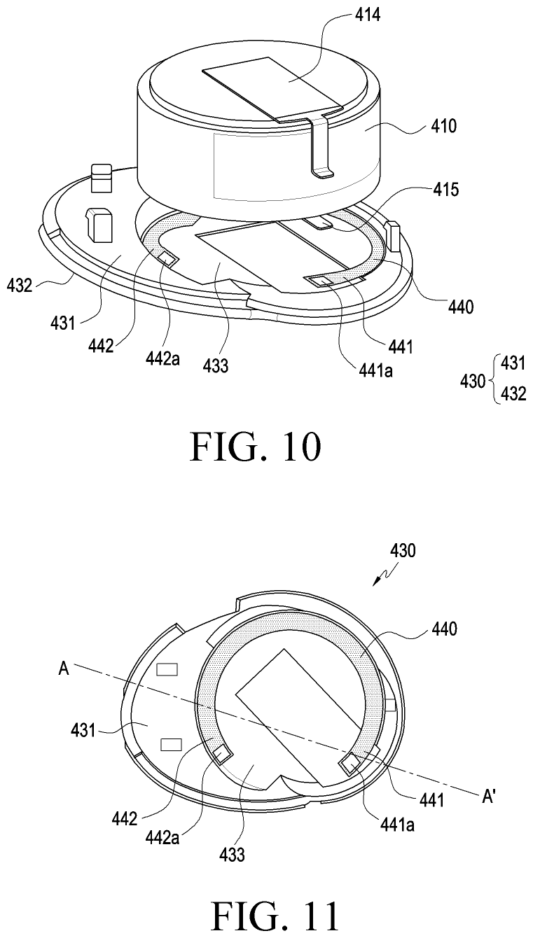

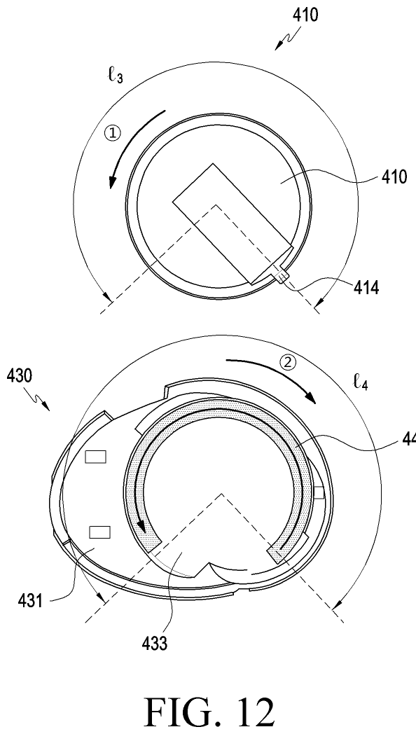

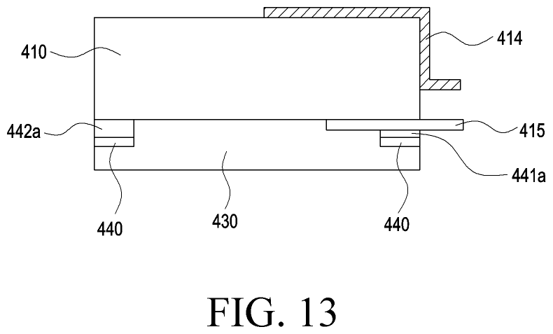

FIG. 10 is an exploded perspective view illustrating the battery 410 and the bracket 430 alone according to an embodiment of the disclosure. FIG. 11 is a diagram illustrating the bracket 430 and the conductive member 440 viewed from above, according to an embodiment of the disclosure. FIG. 12 is a diagram illustrating the directions of current in the battery 410 and the conductive member 440 according to an embodiment of the disclosure. FIG. 13 is a diagram illustrating the battery 410 and the bracket 430 of FIG. 11, taken along line A-A′, according to an embodiment of the disclosure.

Referring to FIGS. 10 to 13, according to an embodiment, an electronic device (e.g., the electronic device 101 in FIG. 1 or the electronic device 300 in FIGS. 3 and 4) may include the battery 410, and the bracket 430 disposed inside the electronic device (e.g., the electronic device 101 in FIG. 1 or the electronic device 300 in FIGS. 3 and 4).

Referring to FIGS. 10 to 13, the configurations of the battery 410 and the bracket 430 in FIGS. 10 to 13 may be wholly or partially identical to those of the battery 410 and the bracket 430 in FIGS. 7, 8A, 8B, and 9. The structures of FIGS. 10 to 13 may be selectively combined with the structures of FIGS. 7, 8A, 8B, and 9.

According to an embodiment, the battery 410 may be seated in the recessed portion 433 of the first surface 431 of the bracket 430. According to an embodiment, the bracket 430 may include the first surface 431 facing the battery 410 (e.g., in the +Y-axis direction in FIG. 4), and the second surface 432 facing the speaker 420 and opposite to the first surface 431 (e.g., in the −Y-axis direction in FIG. 4). The bracket 430 may be configured such that the first surface 431 (e.g., the +Y-axis direction in FIG. 4) faces the battery 410, and the second surface 432 (e.g., the −Y-axis direction in FIG. 4) faces the speaker 420.

According to an embodiment, the conductive member 440 may be a component disposed to cancel out at least a portion of the magnetic field formed in the battery 410. The conductive member 440 may be disposed on the first surface 431 of the bracket 430. The conductive member 440 may be disposed on the recessed portion 433 of the bracket 430. At least a portion of the conductive member 440 may be formed along an edge of the recessed portion 433.

According to an embodiment, the conductive member 440 may contact the battery 410 at two or more points. The conductive member 440 may include a first end 441 electrically connected to a first portion of the battery 410, and a second end 442 electrically connected to a second portion of the battery 410. For example, the first portion of the battery 410 may be an anode tab part, and the second portion of the battery 410 may be defined as the bottom surface of the battery 410 or the exterior member 418 of the battery 410, which has a negative charge. However, the first portion and the second portion of the battery 410 are not limited to the above embodiment, and may be subject to various design modifications according to design methods.

According to an embodiment, the first end 441 of the conductive member 440 and the first portion of the battery 410 may be electrically connected through a first conductive fixed member 441a. According to an embodiment, the second end 442 of the conductive member 440 and the second portion of the battery 410 may be electrically connected through a second conductive fixed member 442a. The conductive fixed members 441a and 442a may be, for example, conductive tapes or conductive gaskets. The conductive fixed members may include, for example, Cu.

According to an embodiment, the length of the conductive member 440 formed along the edge of the recessed portion 433 may be a fourth length 14. The fourth length 14 may be substantially the same as the third length 13 (e.g., the third length 13 in FIG. 9), which is the difference between the lengths of the cathode 411 and the anode 412.

The first current formed to flow in the first winding direction \textcircled{1} may flow in the battery 410 due to the difference between the lengths of the anode 412 and the cathode 411. A second current formed to flow in a second winding direction \textcircled{2} opposite to the first winding direction \textcircled{1} may flow in the conductive member 440 electrically connected to the battery 410. A fourth magnetic field may be formed by the second current. The conductive member 440 may form the fourth magnetic field in a direction opposite to the third magnetic field formed by the first current to cancel out at least a portion of the third magnetic field.

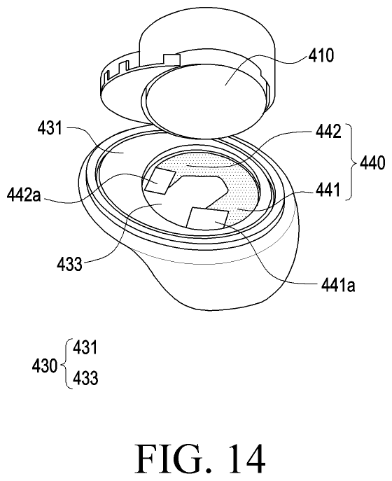

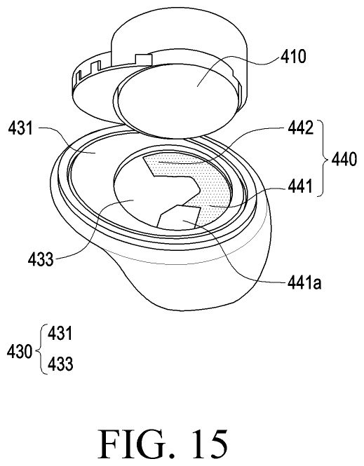

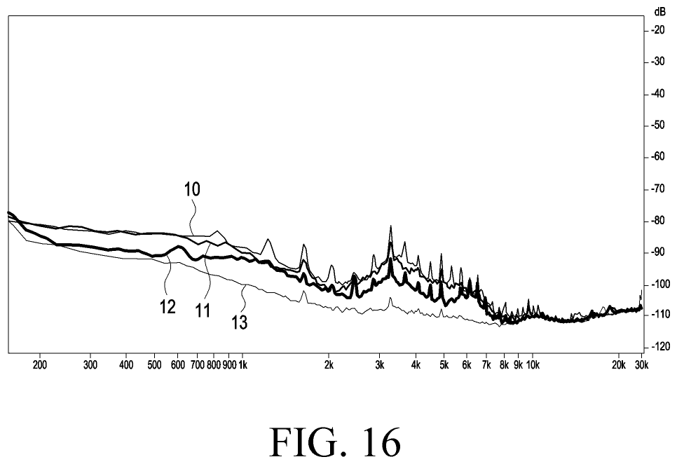

FIG. 14 is a diagram illustrating the conductive member 440 in contact with the battery 410 at two or more points according to an embodiment of the disclosure. FIG. 15 is a diagram illustrating the conductive member 440 in contact with the battery 410 at one point according to an embodiment of the disclosure. FIG. 16 is a diagram illustrating the results of noise measurements based on the number of contact points between the battery 410 and the conductive member 440 according to an embodiment of the disclosure.

Referring to FIGS. 14 to 16, according to an embodiment, an electronic device (e.g., the electronic device 101 in FIG. 1 or the electronic device 300 in FIGS. 3 and 4) may include a housing (e.g., the first housing 310 and the second housing 320 in FIGS. 3 and 4), the battery 410 disposed inside the housing, and the bracket 430.

Referring to FIGS. 14 to 16, the configurations of the battery 410 and the bracket 430 may be wholly or partially identical to those of the battery 410 and the bracket 430 in FIGS. 7, 8A, 8B, and 9 to 13. The structures of FIGS. 14 to 16 may be selectively combined with the structures of FIGS. 7, 8A, 8B, and 9 to 13.

According to an embodiment, referring to FIG. 14, the conductive member 440 may contact the battery 410 at two points. The conductive member 440 may include the first end 441 electrically connected to the first portion of the battery 410, and the second end 442 electrically connected to the second portion of the battery 410. For example, the first portion of the battery 410 may be the anode tab part, and the second portion of the battery 410 may be defined as the bottom surface of the battery 410 or the exterior member 418 of the battery 410, which has a negative charge. The first end 441 of the conductive member 440 and the first portion of the battery 410 may be electrically connected through the first conductive fixed member 441a. According to an embodiment, the second end 442 of the conductive member 440 and the second portion of the battery 410 may be electrically connected through the second conductive fixed member 442a. The conductive fixed members 441a and 442a may be, for example, conductive tape or conductive gaskets. The conductive fixed members may include, for example, Cu. However, the first portion and the second portion of the battery 410 are not limited to the above embodiment, and may be subject to various design modifications according to design methods.

According to an embodiment, referring to FIG. 15, the conductive member 440 may contact the battery 410 at one point. The conductive member 440 may include the first end 441 electrically connected to the first portion of the battery 410. For example, the first portion of the battery 410 may be the anode tab part or the bottom surface (e.g., the exterior member 418 of the battery 410) of the battery 410, which has a negative charge. The first end 441 of the conductive member 440 and the first portion of the battery 410 may be electrically connected through the first conductive fixed member 441a. The first conductive fixed member 441a may be, for example, a conductive tape or a conductive gasket. The first conductive fixed member 441a may include, for example, Cu.

FIG. 16 may illustrate a first graph 10 showing noise generated in an electronic device that does not include the conductive member 440, a second graph 11 showing noise generated in an electronic device that includes the conductive member 440 in contact with the battery 410 at one point, a third graph 12 showing noise generated in an electronic device that includes the conductive member 440 in contact with the battery 410 at two points, and a fourth graph 13 showing ambient noise, which means noise generated from an ambient sound.

According to an embodiment, the second graph 11 and the third graph 12 may illustrate low noise measurements in the electronic device, compared to the first graph 10 without the conductive member 440.

According to an embodiment, the electronic device including the conductive member 440 in contact with the battery 410 at two points may further reduce noise generation than the electronic device including the conductive member 440 in contact with the battery 410 at one point. For example, the noise generated in the electronic device including the conductive member 440 in contact with the battery 410 at two points, as shown in the third graph 12, may be measured to be approximately 11 dB lower than the noise generated in the electronic device without the conductive member 440, as shown in the first graph 10.

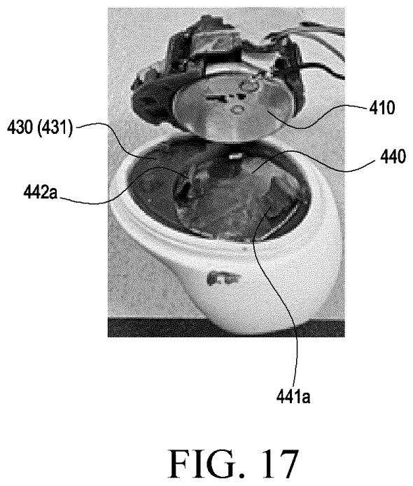

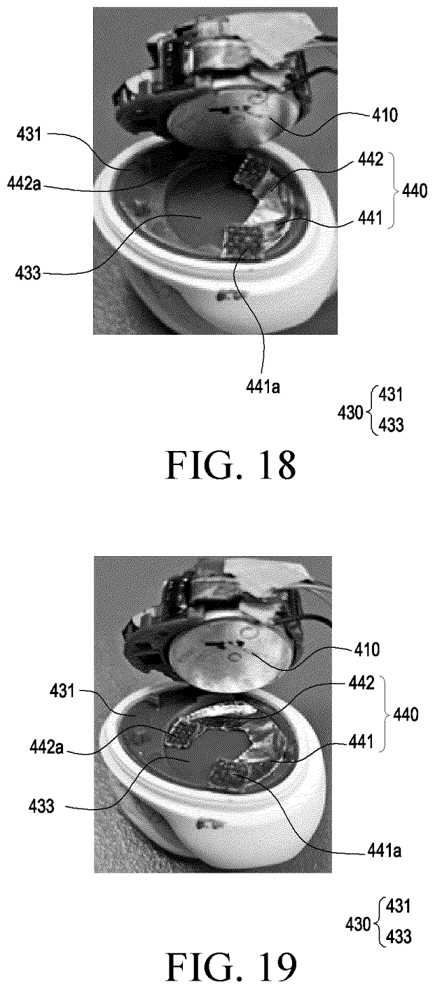

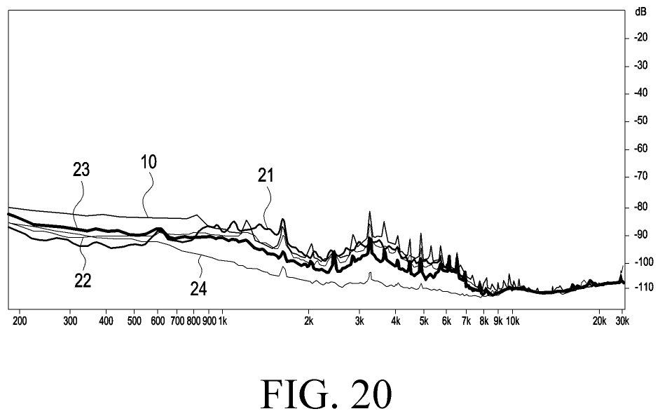

FIG. 17 is a photograph illustrating a circular conductive member 440 according to an embodiment of the disclosure. FIG. 18 is a photograph illustrating a conductive member 440 having a curvature of 180 degrees between the first end 441 and the second end 442 according to an embodiment of the disclosure. FIG. 19 is a photograph illustrating a conductive member 440 having a curvature of 270 degrees between the first end 441 and the second end 442 according to an embodiment of the disclosure. FIG. 20 is a diagram illustrating the results of measuring noise according to the shapes of the conductive members 440 according to an embodiment of the disclosure.

Referring to FIGS. 17 to 20, according to an embodiment, an electronic device (e.g., the electronic device 101 in FIG. 1 or the electronic device 300 in FIGS. 3 and 4) may include a housing (e.g., the first housing 310 and the second housing 320 in FIGS. 3 and 4), the battery 410 disposed inside the housing, and the bracket 430.

Referring to FIGS. 17 to 20, the configurations of the electronic device, the battery 410, and the bracket 430 in FIGS. 17 to 20 may be wholly or partially identical to those of the electronic device, the battery 410, and the bracket 430 in FIGS. 7, 8A, 8B, and 9 to 16. The structures of FIGS. 17 to 20 may be selectively combined with the structures of FIGS. 7, 8A, 8B, and 9 to 16.

FIG. 20 may illustrate a first graph 10 showing noise generated in an electronic device that does not include the conductive member 440, a second graph 21 showing noise generated in an electronic device that includes a circular conductive member 440, a third graph 22 showing noise generated in an electronic device that includes a conductive member 440 having a curvature of 180 degrees between the first end 441 and the second end 442, a fourth graph 23 showing noise generated in an electronic device that includes a conductive member 440 having a curvature of 270 degrees between the first end 441 and the second end 442, and a fifth graph 24 showing ambient noise, which means noise generated from an ambient sound.

According to an embodiment, the noise measurements of the electronic devices in the second graph 21, the third graph 22, and the fourth graph 23 may be low, compared to the first graph 10 without the conductive member 440.

According to an embodiment, the fourth graph 23 may further reduce noise generation than the second graph 21 and the third graph 22.

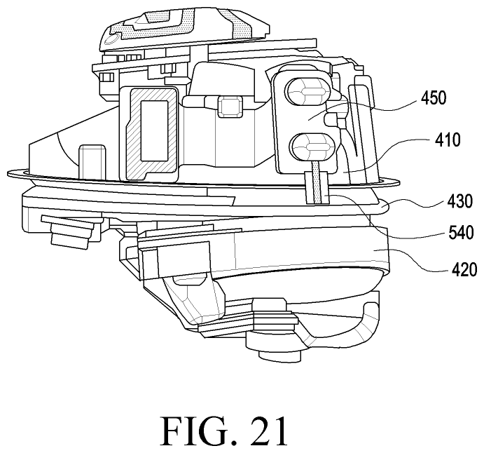

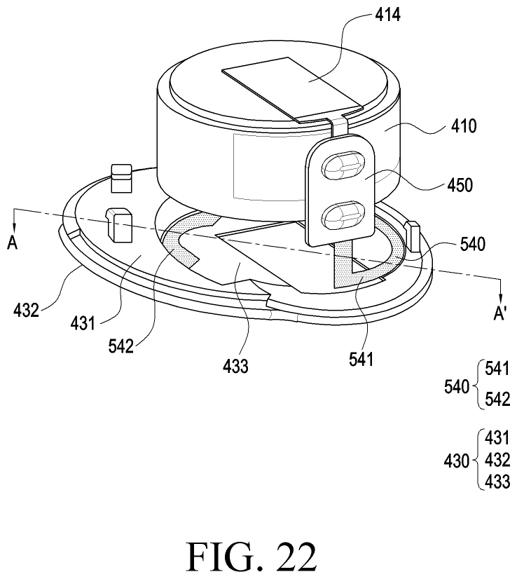

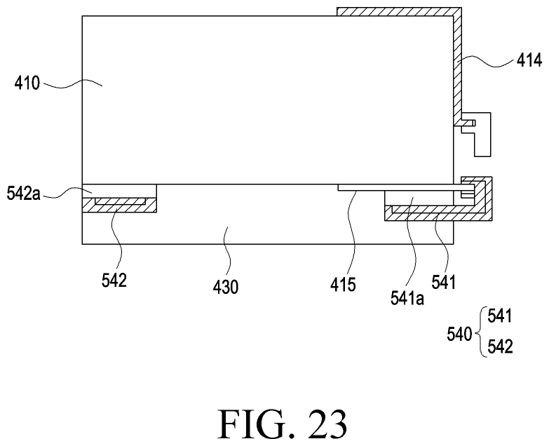

FIG. 21 is a side view illustrating an electronic device (e.g., the electronic device 101 in FIG. 1 or the electronic device 300 in FIGS. 3 and 4) excluding a housing, according to an embodiment of the disclosure. FIG. 22 is an exploded perspective view illustrating the battery 410 and the bracket 430 alone according to an embodiment of the disclosure. FIG. 23 is a diagram illustrating the battery 410 and the bracket 430 of FIG. 22, taken along line A-A′, according to an embodiment of the disclosure.

Referring to FIGS. 21 to 23, the configurations of the battery 410 and the bracket 430 may be wholly or partially identical to those of the battery 410 and the bracket 430 in FIGS. 7, 8A, 8B, and 9 to 20. The structures of FIGS. 21 to 23 may be selectively combined with the structures of FIGS. 7, 8A, 8B, and 9 to 20.

According to an embodiment, the electronic device may further include a third PCB 540. For example, the third PCB may be a conductive FPCB. The third PCB 540 may be extended from the first PCB 450. For example, the third PCB 540 may be extended from the ground line of the first PCB 450. The third PCB 540 may be a component disposed to cancel out at least a portion of the magnetic field formed in the battery 410. The third PCB 540 may be extended from the first PCB 450, with at least a portion thereof disposed on the first surface 431 of the bracket 430. At least a portion of the third PCB 540 may be disposed on the recessed portion 433 of the bracket 430. At least a portion of the third PCB 540 may be formed along the edge of the recessed portion 433.

According to an embodiment, the third PCB 540 may contact the battery 410 at two or more points. The third PCB 540 may include a first end 541 electrically connected to a first portion of the battery 410, and a second end 542 electrically connected to a second portion of the battery 410. For example, the first portion of the battery 410 may be the anode tab part, and the second portion of the battery 410 may be defined as the bottom surface of the battery 410 or the exterior member 418 of the battery 410, which has a negative charge. The first end 541 of the third PCB 540 and the first portion of the battery 410 may be electrically connected through a first conductive fixed member 541a. According to an embodiment, the second end 542 of the third PCB 540 and the second portion of the battery 410 may be electrically connected through a second conductive fixed member 542a. The conductive fixed members 541a and 542a may be, for example, conductive tapes or conductive gaskets. The conductive fixed members may include, for example, Cu. However, the first portion and the second portion of the battery 410 are not limited to the above embodiment, and may be subject to various design modifications according to design methods. According to an embodiment, the length of the third PCB 540 formed along the edge of the recessed portion 433 may be the fourth length. The fourth length may be substantially the same as the third length, which is the difference between the lengths of the cathode 411 and the anode 412.

The first current formed to flow in the first winding direction \textcircled{1} may flow in the battery 410 due to the difference between the lengths of the anode 412 and the cathode 411. The second current formed to flow in the second winding direction \textcircled{2} opposite to the first winding direction \textcircled{1} may flow in the conductive third PCB 540 electrically connected to the battery 410. The fourth magnetic field may be formed by the second current. The third PCB 540 may form the fourth magnetic field in the direction opposite to the third magnetic field formed by the first current to cancel out at least a portion of the third magnetic field. However, the directions of current flowing in the battery 410 and the third PCB 540 are not limited to the above embodiment, and may be subject to various design modifications according to the shape, arrangement relationship, and/or structure of the electronic device.

Generally, the magnetic field generated by the difference between the lengths of the anode (e.g., the anode 412 in FIG. 7) and the cathode (e.g., the cathode 411 in FIG. 7) mounted inside the battery 410 (e.g., the battery 410 in FIG. 7) may affect the adjacent speaker 420 (e.g., the speaker 420 in FIG. 6). For example, current may be induced in the coil (not shown) included inside the speaker 420 by the magnetic field, and this may affect the vibration of the diaphragm (not shown) included inside the speaker 420, causing noise (e.g., an electromagnetic field). For example, periodic noise may occur due to peak current.

According to an embodiment of the disclosure, to mitigate and/or eliminate noise, the bracket 430 including the conductive member 440 that cancels out at least a portion of a magnetic field formed in the battery 410 may be included.

According to an embodiment of the disclosure, an electronic device may include the battery 410 including a cathode having a first length and an anode having a second length different from the first length, the speaker 420 stacked with the battery, and the bracket 430 disposed between the battery and the speaker and having the conductive member 440 on the first surface 431 facing the battery, with at least a portion of the conductive member formed along an edge of the first surface. The conductive member may include the first end 441 electrically connected to a first portion of the battery, and the second end 442 electrically connected to a second portion of the battery. A magnetic field may be formed in the battery by current generated due to a difference between the lengths of the anode and the cathode, and the conductive member may be formed to cancel out at least a portion of the magnetic field.

According to an embodiment, a length of one surface of the conductive member may be a fourth length, and the fourth length may correspond to a third length being the difference between the lengths of the cathode and the anode.

According to an embodiment, the first portion of the battery may be an anode tab, and the second portion may be one surface of the battery facing the bracket.

According to an embodiment, the bracket may include the first surface facing the battery and the second surface 432 facing the speaker, and the first surface may include the recessed portion 433 facing the battery and recessed in a direction towards the speaker.

According to an embodiment, the conductive member may include a curved surface with a curvature of 250 degrees or more and 300 degrees or less between the first end and the second end.

According to an embodiment, the second length may be larger than the first length.

According to an embodiment, the battery may include an electrode assembly in a roll shape in which the cathode and the anode are wound.

According to an embodiment, the electrode assembly may further include the cathode, the anode, a cathode tab connected to the cathode, and the anode tab connected to the anode, and the anode tab may be disposed to cover at least a portion of the one surface of the battery facing the bracket.

According to an embodiment, the electrode assembly may further include a separator disposed between the cathode and the anode.

According to an embodiment, a central axis of the battery may correspond to a central axis of the speaker.

According to an embodiment, the electronic device may further include a conductive fixed member electrically connecting the conductive member and the battery to each other, and the conductive fixed member may be disposed between the first end of the conductive member and the first portion of the battery, or between the second end of the conductive member and the second portion of the battery.

According to an embodiment, the electronic device may further include a first PCB electrically connected to the battery, and the first PCB may include a power line electrically connected to the cathode and a ground line electrically connected to the anode.

According to an embodiment, the electronic device may further include a first conductive PCB extended from the first PCB.

According to an embodiment of the disclosure, an electronic device may include the battery 410 including a cathode having a first length and an anode having a second length different from the first length, the speaker 420 stacked with the battery, the first PCB electrically connected to the battery, the bracket 430 disposed between the battery and the speaker, the first conductive PCB 540 extended from the first PCB. The first conductive PCB 540 may include the first end 441 electrically connected to a first portion of the battery, and the second end 442 electrically connected to a second portion of the battery. A magnetic field may be formed in the battery by current generated due to a difference between the lengths of the anode and the cathode, and the first conductive PCB may be formed to cancel out at least a portion of the magnetic field.

According to an embodiment, a length of one surface of the first conductive PCB may be a fourth length, and the fourth length may correspond to a third length being the difference between the lengths of the cathode and the anode.

According to an embodiment, the first portion of the battery may be an anode tab, and the second portion may be one surface of the battery facing the bracket.

According to an embodiment, the bracket may include the first surface facing the battery and the second surface 432 facing the speaker, and the first surface may include the recessed portion 433 facing the battery and recessed in a direction towards the speaker.

According to an embodiment, the first conductive PCB may include a curved surface with a curvature of 250 degrees or more and 300 degrees or less between the first end and the second end.

According to an embodiment, the second length may be larger than the first length.

According to an embodiment, the battery may include an electrode assembly in a roll shape in which the cathode and the anode are wound.

The battery 410 (e.g., the battery 410 in FIG. 6) and the electronic device (e.g., the electronic device 300 in FIG. 3) including the same according to various embodiments of the disclosure described above are not limited by the afore-described embodiments and drawings. It will be apparent to those skilled in the art that various substitutions, modifications, and changes are possible within the technical scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a battery including a cathode having a first length and an anode having a second length different from the first length;
a speaker stacked with the battery; and
a bracket disposed between the battery and the speaker,
wherein a conductive member is disposed on a first surface of the bracket facing the battery and at least a portion of the conductive member is formed along an edge of the first surface,
wherein the conductive member includes a first end electrically connected to a first portion of the battery, and a second end electrically connected to a second portion of the battery,
wherein the battery is configured such that a magnetic field is formed by current generated due to a difference between the lengths of the anode and the cathode, and
wherein the conductive member is formed to cancel out at least a portion of the magnetic field.

2. The electronic device of claim 1,
wherein a length of one surface of the conductive member is a fourth length, and
wherein the fourth length corresponds to a third length being the difference between the lengths of the cathode and the anode.

3. The electronic device of claim 1, wherein the first portion of the battery is an anode tab, and the second portion is one surface of the battery facing the bracket.

4. The electronic device of claim 1,
wherein the bracket includes the first surface facing the battery and a second surface facing the speaker, and
wherein the first surface includes a recessed portion facing the battery and recessed in a direction towards the speaker.

5. The electronic device of claim 1, wherein the conductive member includes a curved surface with a curvature of 250 degrees or more and 300 degrees or less between the first end and the second end.

6. The electronic device of claim 1, wherein the second length is larger than the first length.

7. The electronic device of claim 1, wherein the battery includes an electrode assembly in a roll shape in which the cathode and the anode are wound.

8. The electronic device of claim 7,
wherein the electrode assembly further includes the cathode, the anode, a cathode tab connected to the cathode, and an anode tab connected to the anode, and
wherein the anode tab is disposed to cover at least a portion of the one surface of the battery facing the bracket.

9. The electronic device of claim 7, wherein the electrode assembly further includes a separator disposed between the cathode and the anode.

10. The electronic device of claim 1, wherein a central axis of the battery corresponds to a central axis of the speaker.

11. The electronic device of claim 1, further comprising:
a conductive fixed member electrically connecting the conductive member and the battery to each other,
wherein the conductive fixed member is disposed between the first end of the conductive member and the first portion of the battery, or between the second end of the conductive member and the second portion of the battery.

12. The electronic device of claim 1, further comprising:
a first printed circuit board electrically connected to the battery,
wherein the first printed circuit board includes a power line electrically connected to the cathode and a ground line electrically connected to the anode.

13. The electronic device of claim 1, further comprising:
a first printed circuit board electrically connected to the battery; and
a third printed circuit board extended from the first printed circuit board.

14. The electronic device of claim 13,
wherein a length of one surface of the third printed circuit board is a fourth length, and
wherein the fourth length corresponds to a third length being a difference between the lengths of the cathode and the anode.

15. The electronic device of claim 13, wherein the third printed circuit board includes a curved surface with a curvature of 250 degrees or more and 300 degrees or less between the first end and the second end.

16. The electronic device of claim 14, wherein the third printed circuit board includes a curved surface with a curvature of 250 degrees or more and 300 degrees or less between the first end and the second end.

17. The electronic device of claim 11, further comprising:
a first printed circuit board electrically connected to the battery,
wherein the first printed circuit board includes a power line electrically connected to the cathode and a ground line electrically connected to the anode.

18. The electronic device of claim 9, wherein a central axis of the battery corresponds to a central axis of the speaker.

19. An electronic device comprising:
a battery including a cathode having a first length and an anode having a second length different from the first length;
a speaker stacked with the battery;
a first printed circuit board electrically connected to the battery;
a bracket disposed between the battery and the speaker; and
a third printed circuit board extended from the first printed circuit board;
wherein the third printed circuit board includes a first end electrically connected to a first portion of the battery, and a second end electrically connected to a second portion of the battery,
wherein the battery is configured such that a magnetic field is formed by current generated due to a difference between the lengths of the anode and the cathode, and
wherein the third printed circuit board is formed to cancel out at least a portion of the magnetic field.

20. The electronic device of claim 19,
wherein a length of one surface of the third printed circuit board is a fourth length, and
wherein the fourth length corresponds to a third length being the difference between the lengths of the cathode and the anode.
